(19) United States
(12) Patent Application Publication
(10) Pub. No.: US 2013/0213303 A1
(43) Pub. Date: Aug. 22, 2013

(54) METHOD FOR DETERMINING THE POSITION OF A NEEDLE FOR INJECTING AND/OR SAMPLING IN AN EGG AND CORRESPONDING SYSTEM

(71) Applicants: Sylvain Comte, Salleboeuf (FR); Fabio Moreira de Souza, Eysines (FR)

(72) Inventors: Sylvain Comte, Salleboeuf (FR); Fabio Moreira de Souza, Eysines (FR)

(73) Assignee: CEVA SANTE ANIMALE, Libourne (FR)

(21) Appl. No.: 13/813,976

(22) PCT Filed: Jul. 25, 2011
(86) PCT No.: PCT/EP2011/062708

§ 371 Date: Apr. 15, 2013

(30) Foreign Application Priority Data
Aug. 5, 2010 (FR) 10/03279

(51) Int. Cl. A01K 45/00

(52) U.S. Cl. CPC A01K 45/007
USPC 119/6.8

(57) ABSTRACT

Disclosed herein is a method for positioning a tip of a needle for injection into and/or removal from an egg. The method includes steps of: measuring at least one electrical parameter characteristic of a target zone to obtain a reference electrical value; measuring the electrical parameter at the tip to obtain a value measured at a position of the tip in the egg; and comparing the measured value with a characteristic reference parameter. A system for determining a position of a tip of a needle for injection into and/or removal from an egg is also disclosed.

### 1. CROSS-REFERENCE TO RELATED APPLICATIONS

This application is a national stage application under 35 U.S.C. 371 of International Patent Application Serial No. PCT/EP2011/062708, entitled “Method for determining the position of a needle for injecting and/or sampling in an egg and corresponding system,” filed Jul. 25, 2011, which claims priority from French Patent Application No. 1003279, filed Aug. 5, 2010, the disclosures of which are hereby incorporated by reference herein in their entirety.

### 2. FIELD OF THE INVENTION

The invention pertains to installations and methods for injecting material into and/or removing material from an avian egg. The invention pertains more particularly to devices and methods for determining the position of a needle in an egg. This determining can be done prior to the injection/removal, concomitantly with the injection/removal or subsequently to the injection/removal. The invention is more particularly intended for the treatment of fertilized eggs of oviparous species, especially poultry.

### 3. BACKGROUND OF THE INVENTION

A certain number of techniques have been elaborated hitherto to enable the in ovo vaccination of embryos, namely the vaccination of embryos when they are still in the egg. It is indeed acknowledged that these in ovo vaccinations enable a reduction of costs, high automation of vaccination and a reduction of stress, and increase the success rate as compared with post-hatching vaccination of chicks.

One of the difficulties of this operation of in ovo vaccination lies in controlling the position of the needle in the egg, since the size of the egg can vary significantly. Indeed, a fertilized egg comprises a plurality of distinct compartments, including the external shell, the air cell, the allantois, the vitellus or yolk, the amniotic fluid and the embryo. Now, vaccination is efficient only if the product is injected into the embryo or the amniotic fluid.

In practice, it is difficult to certify that the injection has been done properly, especially on automated lines for treating avian eggs, such as lines for treating the eggs of future broilers.

One of the approaches commonly used today consists in mixing the injected product with a coloring agent and sampling large quantities of eggs on the vaccination line to verify the quality of the injection. If the egg thus tested is judged to be non-standard, then the injection device is recalibrated.

One of the drawbacks of this method is that it requires the destruction of several thousands of eggs without however ensuring high reproducibility of the vaccination and requires an installation that is cumbersome in terms of staff and time. Another drawback related to this massive destruction of eggs is the impossibility of applying this method routinely and its invasive nature which is not compatible with standards of automation and productivity.

The U.S. Pat. No. 7,617,795 has also proposed a device for controlling the penetration of the needle into the egg. To this end, a stop-forming ring is mounted on the needle at a predetermined distance from the end of the needle delivering the vaccination product, here below called the tip of the needle. Thus, during the insertion of the needle into the egg, the depth of penetration of the needle into the egg is limited by the stop-forming ring. It is thus possible to check the depth of penetration of the needle into the egg and therefore lead the tip of the needle into the area in which the injection has to be made by adjusting the distance between this tip of the needle and the stop-forming ring.

This approach however has the drawback of not being adaptable to each egg, especially when the eggs are being vaccinated in line. In particular, if an egg has a caliber different from that of the egg that has served as a reference to determine the distance between the tip of the needle and the stop-forming ring, then it can happen that the tip is not sufficiently advanced into the egg to reach the amniotic fluid or the embryo or conversely that it is far too advanced and will cause injuries harmful to the embryo. There is therefore a need for a method and a device for determining the position of a needle for injection and/or removal so as to make it possible to control and/or track the position of the needle for injection and/or removal in the egg and ensure vaccination and/or removal under the nominal conditions.

There is also a need for a method for checking the position of a needle in an egg that can be adapted so that, for each egg treated, it is possible to ensure that the vaccination and/or the removal is done under the nominal conditions.

### 4. SUMMARY OF THE INVENTION

Thus, the invention seeks to overcome at least some of the drawbacks of the methods and devices of the prior art.

In particular, the invention seeks to provide a method for determining the position of a needle for injecting and/or removal into and/or from an egg during an operation for injecting or removal.

The invention also seeks to provide a method for determining the position of a needle in an egg that can be used in order to position a needle in a target area of an egg, for example the air cell, the allantois, the vitellus, the amniotic fluid or the embryo, depending on the purpose in view.

The invention is also aimed at providing a method for determining the position of a needle in an egg that can be implemented on an automated egg treatment line.

The invention is also aimed at providing a method for determining the position of the needle in an egg that can be implemented at low cost.

The invention also seeks to propose a device implementing a method according to the invention.

To this end, the invention pertains to a method for assisting in the positioning of a tip of a needle for injection into and/or removal from an egg, comprising the steps of:
measuring at least one electrical parameter characteristic of a target zone in order to obtain a reference electrical value;
measuring said electrical parameter at said tip to obtain a value measured at a position of the tip in the egg;
comparing said measured value with the characteristic reference parameter.

A method according to the invention makes it possible, by the measurement of a characteristic electrical parameter of a medium extending between a first electrode plunged into the egg and a second electrode placed outside the egg, to provide a piece of the information representing the dielectric constant of this medium. The measured value of the electrical parameter then therefore depends on the position of the needle in the egg. In other words, since the medium varies according to the position of the needle, the dielectric constant measured also varies according to the position of the needle in the egg, for example during an operation for injecting a product into and/or removing a product from the egg. In particular, a fertilized egg includes an external shell, an air cell, an allantoic fluid sac, an amniotic fluid sac and the embryo. Thus, the composition of the medium between the two electrodes varies according to the area in which the tip of the needle is placed, where the electrical parameter is measured. If the tip of the needle is in the air cell and the second electrode is placed on the external surface of the shell, the medium will be essentially constituted by air and shell. This means that the dielectric constant of the medium will be close to 1. On the contrary, if the tip of the needle is in the amniotic fluid, the dielectric constant will be greater. The invention therefore makes it possible to determine a zone for locating the needle by analysis of at least one value, in particular a plurality of values, for measuring this characteristic parameter.

The invention also makes it possible to position a needle for injection and/or removal with precision in a target area of an egg by shifting the needle from a first retracted position in which the tip of the needle is outside the egg up to the target zone, in regularly reading the measurements of the characteristic parameter and in comparing them with a table of graphs for example until the measurement corresponds to a measurement of the target zone.

One method according to the invention is especially suited to determining the position of a needle in an egg during an operation for injecting and/or removing a product.

According to another variant, an analysis of the variations of this characteristic parameter is implemented to determine changes of zone by the needle during its movement.

Advantageously, the method furthermore comprises a phase for comparing at least one measured value of the characteristic parameter with a table of ranges of predetermined values, of which each range of values corresponds to a predetermined zone of the egg.

This variant makes it possible to compare the measured value with a table of ranges of predetermined values. This range of values can be fixed and determined in advance or it can be evaluated on the basis of a first measured value, for example during the insertion of the needle into the egg, this value then serving as a reference to determine ranges of values.

A method according to the invention can be used for all types of eggs, especially for the fertilized eggs of an oviparous animal species.

It can be noted that the determined localization zone belongs to the group comprising the air cell of the egg, the allantoic fluid, the amniotic fluid, the embryo and the shell. Such zones correspond to the main zones of a fertilized egg of an oviparous species such as poultry birds.

A method according to the invention therefore makes it possible to determine with precision that zone of the egg in which the tip of the needle for injection and/or removal is situated and therefore to move it if the zone in question does not correspond to a target injection and/or removal zone. For example, in the case of an in ovo vaccination of an embryo, it is necessary for the product to be injected directly into the embryo or into the amniotic fluid. Thus, a method according to the invention ensures efficient vaccination of the embryos.

According to one advantageous variant of the invention, the step for measuring the electrical parameter at the tip is carried out by means of a first electrode at the tip and a second electrode, the method furthermore comprising a step for plunging said second electrode into a conductive solution providing for electrical conduction between the two electrodes by means of this solution.

This conductive solution can for example be a saline solution and/or a chlorinated solution into which the base of the egg is plunged to enable the current to be conducted in the circuit formed by the two electrodes and the egg.

According to another advantageous variant of the invention, the step for measuring an electrical parameter at the tip is carried out by means of a first electrode at said tip and a second electrode, the method furthermore comprising the step for placing said second electrode on the external shell of the egg.

The placing of the second electrode directly on the egg reduces the electrical circuit formed by the electrodes and the egg, thus improving the quality of the measurements of the characteristic parameter. Furthermore, this simplifies the automation of the method on an assembly line. In particular, there is no need for any tank to receive the conductive solution.

Advantageously, and according to this variant, said shell of the egg is furthermore coated with a conductive solution at the level of the contact with said second electrode in order to improve the conduction of current.

Determining the position of the needle for injection and/or removal by a method according to the invention relies on the measurement of a characteristic parameter of a medium demarcated by two electrodes, of which one, namely the primary electrode, is provided at the tip of the needle. This measurement represents the dielectric constant of the medium.

Preferably, the electrical parameter measured is the impedance of the medium. A measurement of impedance is particularly optimized for characterizing a medium and the inventors have noted that this measurement makes it possible to determine the position of the needle in the egg with precision. Furthermore, this measurement is repetitive and the shape of the curves (representing the impedance as a function of the position of the needle in the egg or representing the impedance as a function of time, if the needle is plunged into the egg and/or if the impedance measurements are done periodically at different depths of the needle) is substantially the same, whatever the eggs tested. A method according to this variant therefore enables an automation of the process for checking the position of the needle and therefore for injection and/or removal, by determining impedance jumps from one zone to another.

According to a preferred solution, the needle for injection and/or removal is chosen so as to be partly metallic so as to be able to act as a first electrode. Such a partly metallic needle forms the first electrode, making the detection precise and simplifying the implementation of the method.

A method according to the invention also extends to a method for assisting in the position of a tip of a needle for injecting into and/or removal from an egg comprising the steps of:
measuring at least one characteristic electrical parameter of a target zone in order to obtain a reference electrical parameter;
measuring said electrical parameter at said tip to obtain a measured value while the tip moves forward in the egg;
comparing said measured value with said characteristic reference parameter;
shifting said needle if the measured value does not correspond to the reference electrical parameter until the measured value corresponds to the reference electrical parameter.

A method according to the invention can be used to:
inject a vaccine and/or a pharmaceutical substance;
inject a diagnostic product;
carry out a sexing test;
determine whether the egg is embryonic or not;
carry out removals from certain compartments of the egg.

The invention also pertains to a system for determining the position of a tip of a needle for injection into and/or removal from an egg, comprising:
first means for measuring at least one electrical parameter characteristic of a target zone, intended to provide a reference electrical parameter;
a device comprising:
   a first electrode at the tip of the injection needle,
   a second electrode on the exterior of the egg and electrically connected to the first electrode;
   second means for measuring said electrical parameter between said first electrode and said second electrode;
   means for comparing said reference electrical parameter with a value provided by said second means for measuring.

Such a system enables the implementation of a method according to the invention.

Advantageously, a system according to the invention furthermore comprises means for comparing at least one measured value given by the second means for measuring with a table of ranges of predetermined values, of which each range of values corresponds to a predetermined zone of the egg.

These means for comparing can be digital means, analog means or a combination of digital and analog means. According to one embodiment, they comprise at least one microprocessor, at least one memory and at least one clock. The microprocessor is furthermore suited to processing the measurements and comparing these measurements with predetermined values. These predetermined values can be stored in a memory accessible to the microprocessor before the device is implemented to determine the position of the needle. According to another variant, these predetermined values can be directly evaluated by the microprocessor from a first measurement. The measurements of the table are then computed according to a predefined rule that can be parameterized.

Advantageously, a device according to the invention furthermore comprises a tank for receiving conductive solution adapted to taking the base of the egg, said second electrode being furthermore plunged into the tank for receiving so as to provide for electrical conduction between the two electrodes.

Advantageously, and according to the invention, said second electrode is placed on the external shell of the egg.

Advantageously and according to the invention, said first and second means for measuring are means for measuring an impedance.

These means may be of any type. According to one embodiment, these means comprise a voltage source suited to maintaining voltage at the terminals of the electrodes, an ammeter suited to determining the current flowing between the electrodes and means for computing the impedance from the voltage values and the measured current.

According to a preferred embodiment, said needle for injecting is metallic so as to be able to act as a first electrode.

### 5. BRIEF DESCRIPTION OF THE FIGURES

Other features, characteristics and advantages of the invention shall appear from the following description given purely by way of a non-exhaustive indication and with reference to the appended figures, of which:

FIG. 1 is a schematic view of a device for determining the position of a needle in an egg according to one embodiment of the invention,

FIG. 2 is a schematic view of a device for determining the position of a needle in an egg according to another embodiment of the invention,

FIG. 3 is a schematic view of a detail of a device for determining the position of a needle in an egg according to another embodiment of the invention,

FIG. 4 is a external schematic view of a device according to one embodiment of the invention,

FIG. 5 is schematic view of a curve representing the impedance as a function of the time obtained by the implementing of a method according to one embodiment of the invention with a device according to one embodiment of the invention during an operation for injecting.

### 6. DETAILED DESCRIPTION

In the figures, the scales and the proportions are not strictly complied with for purposes of illustration and clarity.

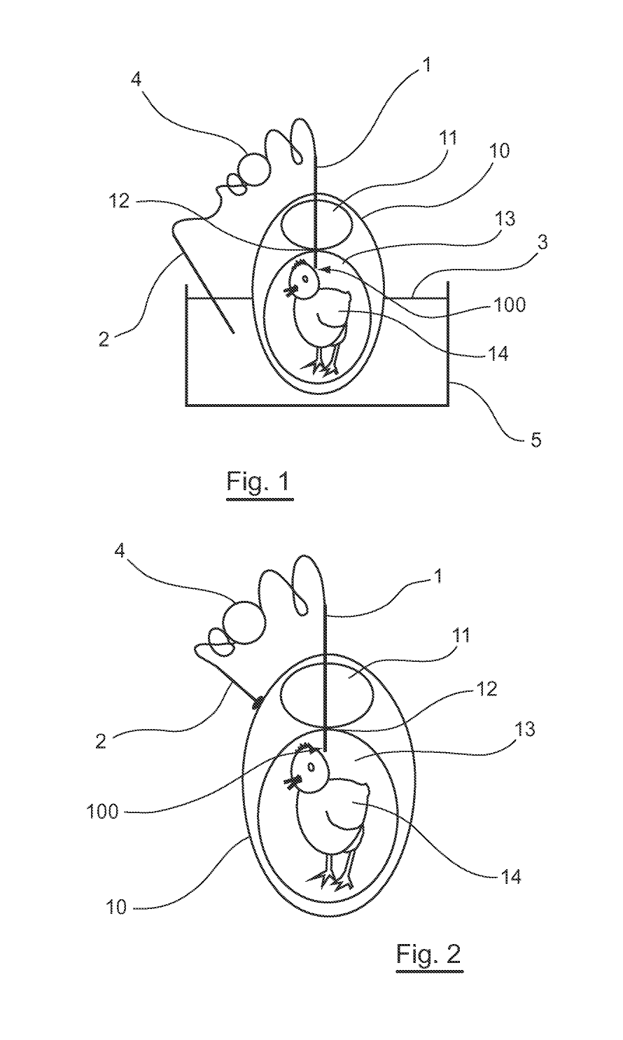

Throughout the detailed description that follows with reference to the figures, unless otherwise indicated, each element of the devices described is described as it is laid out when the device is in operation, i.e. when the needle for injecting and/or removal is inserted into an egg from its top end. This layout is shown especially in FIGS. 1 and 2.

The figures represent a device for determining the position of a needle for injecting which can be used to determine the position of the needle in order to inject a product of any type into an egg. This product can be a vaccine, a vitamin, a probe, a coloring agent and generally any liquid and/or gaseous substance necessary for the treatment or diagnosis of an avian egg. The invention nevertheless also pertains to a device for determining the position of a needle for removing a substance inside the egg. Those skilled in the art will have no difficulty in replacing the needle for injecting described in the following description by a needle for removal in order to obtain this alternative embodiment.

According to the embodiment of FIG. 1, the device comprises a conductive metallic needle 1 for injecting forming a first electrode, the terminal part of which is constituted by the tip 100 of the needle. The device also comprises a second electrode 2 plunged into a conductive solution 3.

The device according to this embodiment also comprises means 4 for measuring impedance (as a characteristic electrical parameter of a medium) of the medium between the first electrode 1 and the second electrode 2. These measurements are then analyzed by a processing unit (not shown in the figures) to determine an area for localizing the needle in the egg.

In practice, the impedance is measured as and when the needle moves in the egg. In other words, an impedance value is obtained at a position of the tip in the egg, the operations for measuring being performed continuously to obtain a reading of the variation of impedance as a function of the shifting of the needle in the egg.

The impedance measuring means 4 include, according to one embodiment of the invention, a voltage source, an ammeter and a computation unit to compute the impedance from the measured values of current and the value of voltage. The voltage source can for example deliver a voltage of 4 V at the frequency of 1 MHz. These values provide efficient results on chickens' eggs. That said, other parameters can be used without affecting the results obtained. It is nevertheless necessary to choose parameters that limit the exposure of the embryo to current to avoid damaging it.

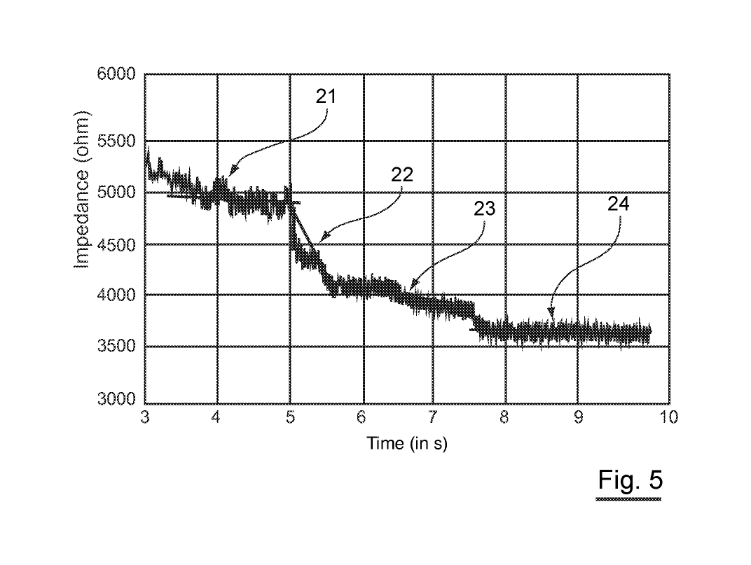

FIG. 5 presents the results obtained during a plunging of the needle 1 into the egg 10 from its tip until the needle is in contact with the embryo 14 (schematically represented in the figures by a chick for purpose of clarity).

This curve has four clearly distinct portions represented schematically by the references 21, 22, 23 and 24.

The portion 21 represents the impedance values measured by the device according to the embodiment of FIGS. 1 and 2 when the needle 1 is in the air pouch or cell represented by the reference 11 in FIGS. 1 and 2. The portion 22 represents the impedance values measured by the device according to the embodiment of FIGS. 1 and 2 when the needle 1 is in the allantoic fluid represented by the reference 12 in FIGS. 1 and 2. The portion 23 represents the impedance values measured by the device according to the embodiment of FIGS. 1 and 2 when the needle 1 is in the amniotic fluid represented by the reference 13 in FIGS. 1 and 2. The portion 24 represents the impedance values measured by the device according to the embodiment of FIGS. 1 and 2 when the needle 1 is in the embryo 14.

According to the invention, the position of the needle 1 in the egg 10 can therefore be defined by determining the range of values in which the impedance is situated. For example, according to FIG. 4, if the impedance measured by the device is 3995 ohms, then this value belongs to the portion 23 of the curve, indicating that the needle is in the zone of the amniotic fluid 13.

In a system according to the invention, the device that has just been described is associated with first means for measuring (the means 4 for measuring the impedance of the device constituting second means for measuring) the impedance of the target zone in order to obtain a reference electrical parameter.

It can be noted that these first means for measuring (not shown) can be implemented in a phase that is completely dissociated from the phase for injecting or removing during which the device described here above is implemented.

The means for determining a zone for locating the needle comprise, according to one embodiment, a microprocessor, at least one memory and a clock used to synchronize the operations of the microprocessor. According to one embodiment of the invention, this memory comprises a software program adapted to determining the zone of location from measurements delivered by the measuring means and stored for example in said memory of the determining means. This software program then implements the processing steps of a method according to one embodiment of the invention. In one embodiment, these steps consist in determining the range of values in which the last measurement of a characteristic parameter is situated. According to another embodiment, the means for determining are a combination of a hardware element and a software sub-program or even a combination of several software modules. These means for determining also preferably serve as means for comparing at least one value (measured by the second measuring means) with a table of values (constituted by means of values measured by the first measuring means), for example stored in the memory.

The values of impedance of the table set up with the first measuring means are stored in a memory accessible by the means for determining the zone. Starting from the instant when the needle enters the interior of the egg, the values of impedance measured by the second measuring means (the first and second electrodes) are compared with the impedance values of the memorized table.

It can be noted that the table can comprise ranges of values each corresponding to one of the zones of the egg (air cell, allantoic fluid, amniotic fluid, embryo and shell).

A device according to the invention therefore enables the detection of at least the zones corresponding to the air cell, the allantoic fluid, the amniotic fluid and the embryo.

The second electrode 2 is, according to the embodiment of FIG. 1, plunged into a tank 5 for receiving a conductive solution 3. This tank for receiving is furthermore suited to taking the base of the egg 10.

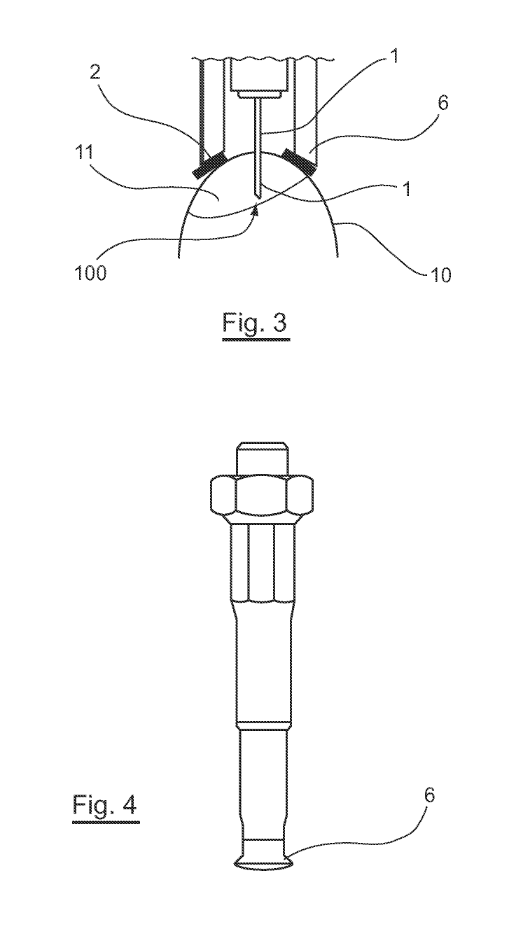

According to another embodiment as shown in FIGS. 2 and 3, the second electrode is directly placed on the shell of the egg 10. To this end and as shown in FIGS. 3 and 4, the electrode can be formed on a suction cup 6 designed to take support against the egg 12 during the treatment of the egg on an automatic treatment line. This suction cup 6 is, according to this embodiment, metalized so that it can conduct current. Such a layout is particularly intended for and suited to installation on an automatic egg treatment line. In the embodiment of FIGS. 2 and 3, where the electrode 2 is directly placed on the egg, it is also planned to have a means to coat the contact zone with a conductive solution so as to improve the conduction. This conductive solution can be conveyed by any type of means. According to one advantageous embodiment, the electrode 2 is positioned so that the contact with the egg 10 is made in the immediate vicinity of the zone where the droplets of disinfectant, for example chlorinated disinfectant, are provided on the automatic egg treatment line.

FIG. 4 is a schematic view of a device for injecting in which the device according to the invention can be installed. This device for injecting comprises a suction cup 4 that is to come into contact with the egg 20 and a longitudinal tube comprising the injection needle as well as a device for moving the needle along the longitudinal direction. FIG. 3 is a view in partials section of the device of FIG. 4 showing the needle 1 forming the first electrode and the suction cup 6 forming the second electrode.

According to another embodiment, the needle is not metallic but fixedly carries a metal electrode in the vicinity of the end of the needle carrying the injection opening. This architecture is less advantageous but can be preferred for certain injections prohibiting a use of a metal needle or to transform and improve an existing device for injecting in providing it with the functions of the device according to the invention.

The invention also pertains to a method for determining the position of a needle in an egg.

A method according to the invention can advantageously be used to implement a method for injecting a substance into and/or removing a substance from an egg. Such a method comprises for example the steps consisting in:
fixedly joining a first electrode to the needle for injecting or providing a current-conducting needle, for example a metal needle,
connecting said first electrode to a second electrode placed outside the egg, preferably in contact with the shell of the egg by means of a conductive solution,
inserting the needle and the first electrode into the egg,
measuring the impedance between the electrodes regularly during the moving of the needle in a direction going from the tip of the egg to its base,
determining for each measurement the zone of presence of the needle in the egg,
injecting and/or removing the substance if the determined zone corresponds to the target zone of injection and/or removal.

A method according to the invention and a device according to the invention are not limited solely to the embodiments described and can find applications other than those described. In particular, a device according to the invention can be connected to various computation and analysis modules making it possible for example to obtain statistics on the values of characteristic parameters read during the operations for injecting and/or removal.

A method according to the invention can be used to:
inject a vaccine and/or pharmaceutical substance such as a hormone, a vitamin, etc;
inject a diagnostic product such as a probe to diagnose a pathology, a deformation or again to verify that a vaccine has been injected;
to carry out a sexing test;
carry out a removal, for example to carry out a quality test.

A method and a system according to the invention can also be used to determine the presence or absence of an embryo in the egg. In particular, hitherto the technique used to determine the presence of an embryo is the mirage technique. In this method, a strong light is focused on the egg which is visually inspected. A method and the system according to the invention therefore enable another means for detecting the presence of an embryo, this means being more robust than the mirage technique because it does not rely on the human eye and furthermore enables easy automation of the detection method.

In practice, with knowledge of the characteristic reference electrical parameter of an embryo, in the form of a range of impedance values, it is possible to check whether or not the value measured at the tip of the needle comes within said range of impedance values. If, after a predetermined travel of the tip of the needle in the egg, the measured value is not in the range of impedance values, it will be deduced that the egg does not contain any embryos.

1. A method for positioning a tip of a needle for injection into and/or removal from an egg, the method comprising:
measuring at least one electrical parameter characteristic of a target zone to obtain a reference electrical value;
measuring the electrical parameter at the tip to obtain a value measured at a position of the tip in the egg; and
comparing the measured value with a characteristic reference parameter.

2. The method according to claim 1, further comprising comparing at least one measured value of the characteristic parameter with a table of ranges of predetermined values, wherein each range of values corresponds to a predetermined zone of the egg.

3. The method according to claim 1, wherein the step for measuring the electrical parameter at the tip is carried out by means of a first electrode at the tip and a second electrode, the method further comprising a step of plunging the second electrode into a conductive solution in which a base of the egg is also bathed to provide electrical conduction between the first and second electrodes by means of this conductive solution and the egg.

4. The method according to claim 1, wherein the step of measuring the electrical parameter at the tip is carried out by means of a first electrode at the tip and a second electrode, the method further comprising placing the second electrode on an external shell of the egg.

5. The method according to claim 4, wherein the shell of the egg is furthermore coated with a conductive solution at a level at which the shell contacts the second electrode.

6. The method according to claim 1, wherein the characteristic electrical parameter measured is an impedance of the a medium in which the tip is placed.

7. The method according to claim 1, wherein the needle is metallic and can act as a first electrode.

8. A system for determining a position of a tip of a needle for injection into and/or removal from an egg, the system comprising:
means for measuring at least a first electrical parameter characteristic of a target zone to provide a reference electrical parameter;
a device comprising:
a first electrode at the tip of the injection needle,
a second electrode on an exterior of the egg, wherein the second electrode is electrically connected to the first electrode;
means for measuring a second electrical parameter between the first electrode and the second electrode;
means for comparing the reference electrical parameter with a value provided by the means for measuring the electrical parameter between the first electrode and the second electrode.

9. The system according to claim 8, comprising means for comparing at least one value given by means for measuring the electrical parameter between the first electrode and the second electrode with a table of ranges of predetermined values, wherein each range of values corresponds to a predetermined zone of the egg.

10. The system according to claim 8, further comprising a tank for receiving a conductive solution configured to contact a base of the egg, wherein the second electrode is plunged into tank.

11. The system according to claim 8, wherein the second electrode is configured to be placed on an external shell of the egg.

12. The system according to claim 8, wherein the means for measuring at least the first electrical parameter characteristic of the target zone to provide the reference electrical parameter and the means for measuring the second electrical parameter between the first electrode and the second electrode comprise means for measuring an impedance.

13. The system according to claim 8, wherein the needle for injecting and/or removal is metallic and can function as a first electrode.

14. The method according claim 1, wherein the needle is used to inject a vaccine and/or a pharmaceutical substance.

15. The method according claim 1, wherein the needle is used to inject a diagnostic product.

16. The method according claim 1, wherein the needle is used to carry out a sexing test.

17. The method according claim 1, wherein the needle is used to determine whether the egg is embryonic or not.

18. The method according claim 1, wherein the needle is used to remove a specific compartment of the egg.
